(19) United States
(12) Patent Application Publication
(10) Pub. No.: US 2022/0013908 A1
(43) Pub. Date: Jan. 13, 2022

(54) MOBILE DEVICE

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 17/024,020

(22) Filed: Sep. 17, 2020

(30) Foreign Application Priority Data
Jul. 10, 2020 (TW) 109123338

(51) Int. Cl. H01Q 5/35; H01Q 13/16; H01Q 1/38

(52) U.S. Cl. CPC H01Q 5/35; H01Q 1/38; H01Q 13/16

(57) ABSTRACT

A mobile device includes a metal mechanism element, a first radiation element, a second radiation element, and a dielectric substrate. A closed slot is formed in the metal mechanism element. The closed slot has a first edge and a second edge which are opposite to each other. The first radiation element has a feeding point. The second radiation element is coupled to the first edge of the closed slot, and is adjacent to the first radiation element. The second radiation element is at least partially disposed between the first radiation element and the second edge of the closed slot. The first radiation element and the second radiation element are disposed on the dielectric substrate. An antenna structure is formed by the first radiation element, the second radiation element, and the closed slot of the metal mechanism element.

### CROSS REFERENCE TO RELATED APPLICATIONS

This application claims priority of Taiwan Patent Application No. 109123338 filed on Jul. 10, 2020, the entirety of which is incorporated by reference herein.

### BACKGROUND OF THE INVENTION

### Field of the Invention

The disclosure generally relates to a mobile device, and more particularly, it relates to a mobile device and an antenna structure therein.

### Description of the Related Art

With the advancements being made in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, 2500 MHz, and 2700 MHz. Some devices cover a small wireless communication area; these include mobile phones using Wi-Fi and Bluetooth systems and using frequency bands of 2.4 GHz, 5.2 GHz, and 5.8 GHz.

In order to improve their appearance, designers often incorporate metal elements into mobile devices. However, these newly added metal elements tend to negatively affect the antennas used for wireless communication in mobile devices, thereby degrading the overall communication quality of the mobile devices. As a result, there is a need to propose a mobile device with a novel antenna structure, so as to overcome the problems of the prior art.

### BRIEF SUMMARY OF THE INVENTION

In an exemplary embodiment, the disclosure is directed to a mobile device that includes a metal mechanism element, a first radiation element, a second radiation element, and a dielectric substrate. A closed slot is formed in the metal mechanism element. The closed slot has a first edge and a second edge which are opposite to each other. The first radiation element has a feeding point. The second radiation element is coupled to the first edge of the closed slot, and is disposed adjacent to the first radiation element. The second radiation element is at least partially disposed between the first radiation element and the second edge of the closed slot. The first radiation element and the second radiation element are disposed on the dielectric substrate. An antenna structure is formed by the first radiation element, the second radiation element, and the closed slot of the metal mechanism element.

In some embodiments, the closed slot of the metal mechanism element substantially has a rectangular shape.

In some embodiments, the first radiation element substantially has a relatively short L-shape, and the second radiation element substantially has a relatively long L-shape.

In some embodiments, the first radiation element has a first vertical projection on the metal mechanism element. The second radiation element has a second vertical projection on the metal mechanism element. The whole first vertical projection and the whole second vertical projection are inside the closed slot.

In some embodiments, a coupling gap is formed between the first radiation element and the second radiation element. The width of the coupling gap is shorter than or equal to 2 mm.

In some embodiments, the first radiation element includes a first portion and a second portion which are substantially perpendicular to each other. The second radiation element includes a third portion and a fourth portion which are substantially perpendicular to each other. The fourth portion of the second radiation element is substantially parallel to the second portion of the first radiation element.

In some embodiments, the second portion of the first radiation element has a first open end. The fourth portion of the second radiation element has a second open end. The second open end and the first open end substantially extend in directions that are substantially the same or opposite.

In some embodiments, the antenna structure covers a first frequency band from 2400 MHz to 2500 MHz, and a second frequency band from 5150 MHz to 5850 MHz.

In some embodiments, the length of the first radiation element is substantially equal to 0.25 wavelength of the second frequency band.

In some embodiments, the length of the second radiation element is from 0.25 to 0.5 wavelength of the first frequency band.

### BRIEF DESCRIPTION OF DRAWINGS

The invention can be more fully understood by reading the subsequent detailed description and examples with references made to the accompanying drawings, wherein:

FIG. 1 is a top view of a mobile device according to an embodiment of the invention;

FIG. 2 is a sectional view of a mobile device according to an embodiment of the invention;

FIG. 3 is a diagram of return loss of an antenna structure of a mobile device according to an embodiment of the invention;

FIG. 4 is a diagram of radiation efficiency of an antenna structure of a mobile device according to an embodiment of the invention;

FIG. 5 is a top view of a mobile device according to another embodiment of the invention; and

FIG. 6 is a diagram of a notebook computer according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

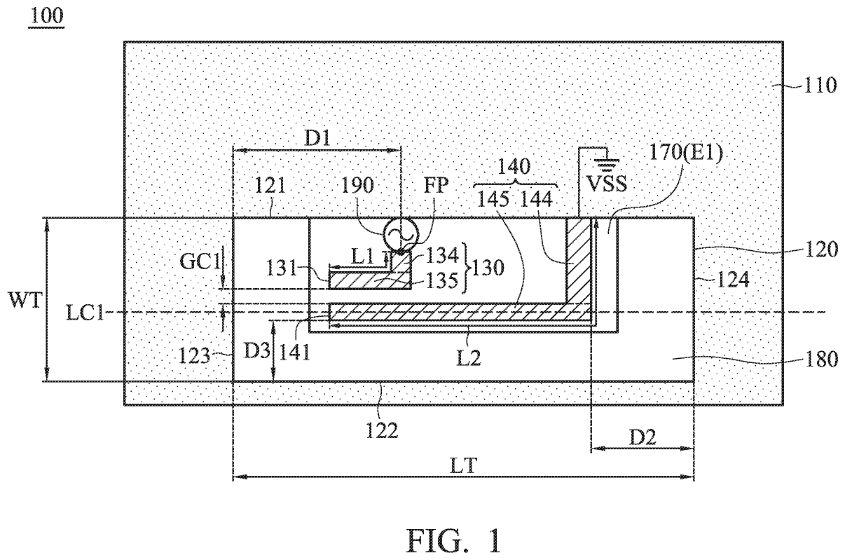

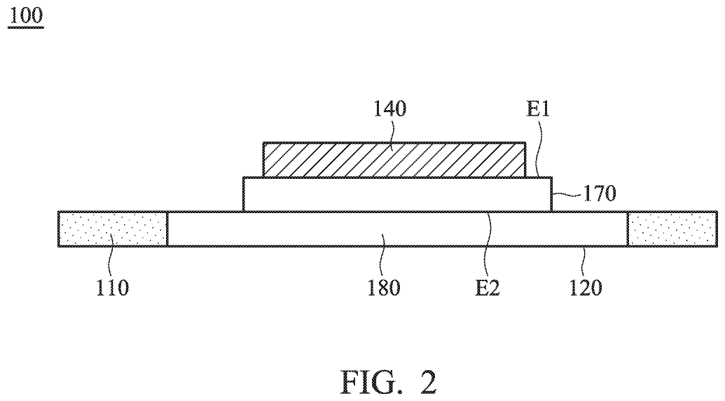

FIG. 1 is a top view of a mobile device 100 according to an embodiment of the invention. FIG. 2 is a sectional view of the mobile device 100 according to an embodiment of the invention (along a sectional line LC1 of FIG. 1). Please refer to FIG. 1 and FIG. 2 together. The mobile device 100 may be a smartphone, a tablet computer, or a notebook computer. In the embodiment of FIG. 1 and FIG. 2, the mobile device 100 at least includes a metal mechanism element 110, a first radiation element 130, a second radiation element 140, and a dielectric substrate 170. It should be understood that the mobile device 100 may further include other components, such as a processor, a touch control panel, a speaker, a battery module, and a housing, although they are not displayed in FIG. 1 and FIG. 2.

The metal mechanism element 110 may be an appearance element of the mobile device 100. It should be noted that the so-called “appearance element” over the disclosure means a portion of the mobile device 100 which a user's eyes can directly observe. In some embodiments, the metal mechanism element 110 is a metal top cover of a notebook computer or a metal back cover of a tablet computer, but it is not limited thereto. For example, if the mobile device 100 is a notebook computer, the metal mechanism element 110 may be “A-component” in the field of notebook computers.

A closed slot 120 is formed in the metal mechanism element 110. The closed slot 120 of the metal mechanism element 110 may substantially have a rectangular shape. Specifically, the closed slot 120 of the metal mechanism element 110 has a first edge 121, a second edge 122, a third edge 123, and a fourth edge 124. The second edge 122 is opposite and substantially parallel to the first edge 121. The fourth edge 124 is opposite and substantially parallel to the third edge 123. In addition, the length of each of the first edge 121 and the second edge 122 is longer than the length of each of the third edge 123 and the fourth edge 124. In some embodiments, the mobile device 100 may further include a nonconductive material 180, which fills the closed slot 120 of the metal mechanism element 110, so as to achieve the waterproof or dustproof functions. However, the invention is not limited thereto. In alternative embodiments, the nonconductive material 180 is removable from the closed slot 120 of the metal mechanism element 110, without affecting the performance of the invention.

The first radiation element 130 and the second radiation element 140 may both be made of metal materials, such as copper, silver, aluminum, iron, or their alloys. The dielectric substrate 170 may be an FR4 (Flame Retardant 4) substrate, a PCB (Printed Circuit Board), or an FCB (Flexible Circuit Board). The dielectric substrate 170 has a first surface E1 and a second surface E2 which are opposite each other. The first radiation element 130 and the second radiation element 140 are disposed on the first surface E1 of the dielectric substrate 170. The second surface E2 of the dielectric substrate 170 is adjacent to the metal mechanism element 110. It should be noted that the term “adjacent” or “close” over the disclosure means that the distance (spacing) between two corresponding elements is smaller than a predetermined distance (e.g., 5 mm or shorter), or means that the two corresponding elements directly touch each other (i.e., the aforementioned distance/spacing therebetween is reduced to 0). In some embodiments, the second surface E2 of the dielectric substrate 170 is directly attached to the nonconductive material 180 in the closed slot 120, and thus the dielectric substrate 170 at least partially overlaps the closed slot 120 of the metal mechanism element 110.

A ground voltage VSS of the mobile device 100 may be provided by a ground element (not shown). The ground element may be coupled to the metal mechanism element 110. For example, the ground element may be a ground copper foil which extends from the dielectric substrate 170 onto the metal mechanism element 110.

The first radiation element 130 may substantially have a relatively short L-shape. Specifically, the first radiation element 130 includes a first portion 134 and a second portion 135 which are substantially perpendicular to each other. A feeding point FP is positioned at an end of the first portion 134. The second portion 135 has a first closed end 131. The feeding point FP may be further coupled to a signal source 190. For example, the signal source 190 may be an RF (Radio Frequency) module for exciting an antenna structure of the mobile device 100. In some embodiments, the first radiation element 130 has a first vertical projection on the metal mechanism element 110, and the whole first vertical projection is inside the closed slot 120.

The second radiation element 140 may substantially have a relatively long L-shape. The second radiation element 140 is at least partially disposed between the first radiation element 130 and the second edge 122 of the closed slot 120. Specifically, the second radiation element 140 includes a third portion 144 and a fourth portion 145 which are substantially perpendicular to each other. The third portion 144 is coupled to the first edge 121 of the closed slot 120 (i.e., the ground voltage VSS). The fourth portion 145 has a second open end 141. The second open end 141 of the second radiation element 140 and the first open end 131 of the first radiation element 130 may substantially extend in the same direction. The second radiation element 140 is adjacent to the first radiation element 130, but the second radiation element 140 is completely separate from the first radiation element 130. A coupling gap GC1 is formed between the fourth portion 145 of the second radiation element 140 and the second portion 135 of the first radiation element 130. The fourth portion 145 of the second radiation element 140 may be substantially parallel to the second portion 135 of the first radiation element 130. Furthermore, the fourth portion 145 of the second radiation element 140 may be positioned between the second portion 135 of the first radiation element 130 and the second edge 122 of the closed slot 120. In some embodiments, the second radiation element 140 has a second vertical projection on the metal mechanism element 110, and the whole second vertical projection is inside the closed slot 120.

In preferred embodiment, the antenna structure of the mobile device 100 is formed by the first radiation element 130, the second radiation element 140, and the closed slot 120 of the metal mechanism element 110. The closed slot 120 of the metal mechanism element 110 is excited by the first radiation element 130 and the second radiation element 140 using a coupling mechanism.

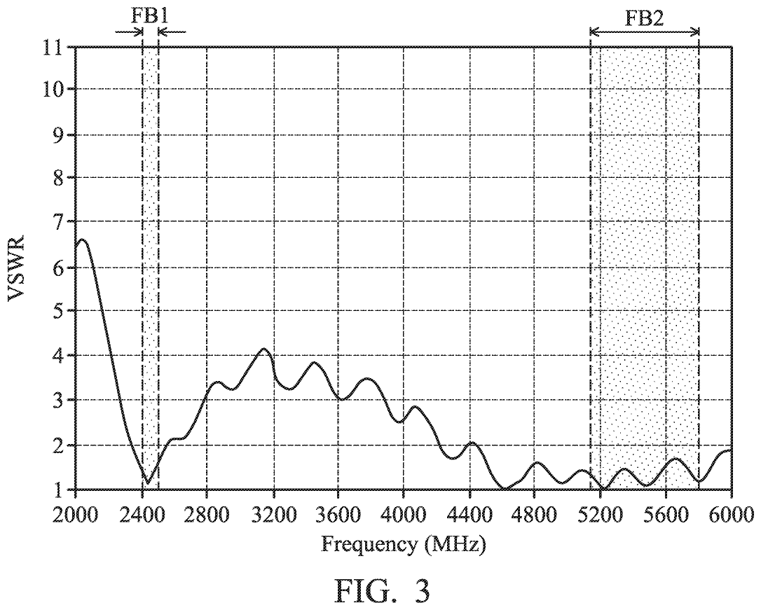

FIG. 3 is a diagram of return loss of the antenna structure of the mobile device 100 according to an embodiment of the invention. The horizontal axis represents the operation frequency (MHz), and the vertical axis represents the return loss (dB). According to the measurement of FIG. 3, when being excited by the signal source 190, the antenna structure of the mobile device 100 can cover a first frequency band FB1 and a second frequency band FB2. For example, the first frequency band FB1 may be from 2400 MHz to 2500 MHz, and the second frequency band FB2 may be from 5150 MHz to 5850 MHz. Therefore, the antenna structure of the mobile device 100 can support at least the wideband operations of WLAN (Wireless Local Area Networks) 2.4 GHz/5 GHz.

With respect to the antenna theory, the first radiation element 130, the second radiation element 140, and the closed slot 120 of the metal mechanism element 110 can be excited to generate the first frequency band FB1 and the second frequency band FB2. According to practical measurements, the incorporation of the first radiation element 130 and the second radiation element 140 can help to fine-tune the impedance matching of the first frequency band FB1 and the second frequency band FB2, and also increase the operation bandwidths of the first frequency band FB1 and the second frequency band FB2.

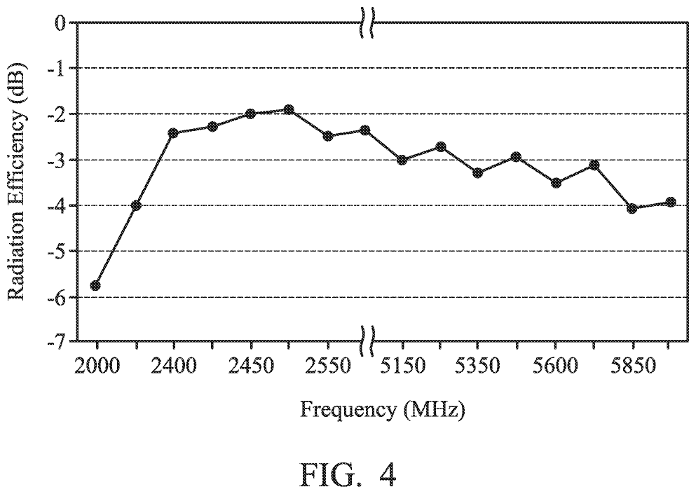

FIG. 4 is a diagram of radiation efficiency of the antenna structure of the mobile device 100 according to an embodiment of the invention. The horizontal axis represents the operation frequency (MHz), and the vertical axis represents the radiation efficiency (dB). According to the measurement of FIG. 4, the radiation efficiency of the antenna structure of the mobile device 100 can reach −4 dB or higher within the first frequency band FB1 and the second frequency band FB2, and it can meet the requirement of practical application of general mobile communication devices.

In some embodiments, the element sizes of the mobile device 100 are described as follows. The length LT of the closed slot 120 of the metal mechanism element 110 (i.e., the length of the first edge 121 or the second edge 122) may be from 35 mm to 50 mm. The width WT of the closed slot 120 of the metal mechanism element 110 (i.e., the length of the third edge 123 or the fourth edge 124) may be from 10 mm to 15 mm. The length L1 of the first radiation element 130 (i.e., the total length of the first portion 134 and the second portion 135) may be substantially equal to 0.25 wavelength (λ/4) of the second frequency band FB2 of the antenna structure of the mobile device 100. In the first radiation element 130, the length of the second portion 135 may be from 1 to 2 times the length of the first portion 134. The length L2 of the second radiation element 140 (i.e., the total length of the third portion 144 and the fourth portion 145) may be from to 0.25 to 0.5 wavelength (λ/4˜λ/2) of the first frequency band FB1 of the antenna structure of the mobile device 100. In the second radiation element 140, the length of the fourth portion 145 may be from 2 to 3 times the length of the third portion 144. The width of the coupling gap GC1 between the fourth portion 145 of the second radiation element 140 and the second portion 135 of the first radiation element 130 may be shorter than or equal to 2 mm. The distance D1 between the feeding point FP and the third edge 123 of the closed slot 120 may be from 5 mm to 10 mm. The distance D2 between the third portion 144 of the second radiation element 140 and the fourth edge 124 of the closed slot 120 may be from 5 mm to 10 mm. The distance D3 between the fourth portion 145 of the second radiation element 140 and the second edge 122 of the closed slot 120 may be longer than or equal to 5 mm. The ranges of the above element sizes are calculated and obtained according to many experiment results, and they help to optimize the operation bandwidth and impedance matching of the antenna structure of the mobile device 100.

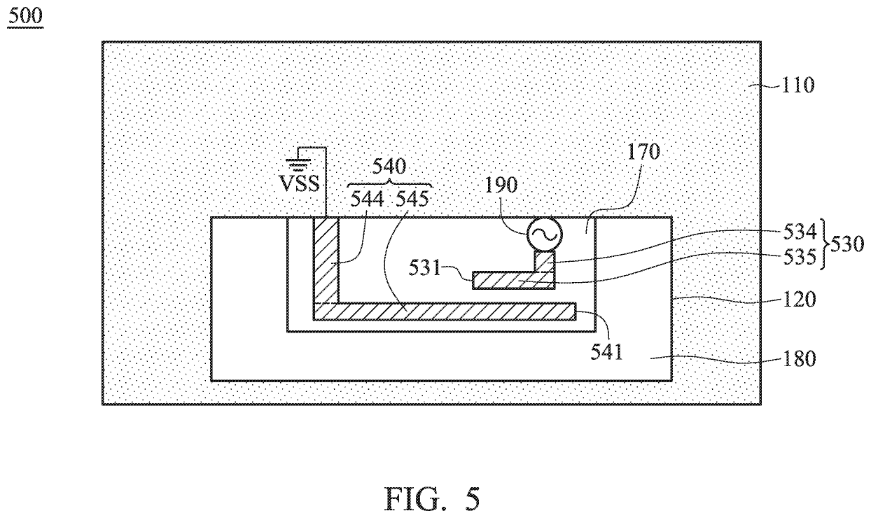

FIG. 5 is a top view of a mobile device 100 according to another embodiment of the invention. In the embodiment of FIG. 5, a first radiation element 530 of the mobile device 500 includes a first portion 534 and the second portion 535, and a second radiation element 540 of the mobile device 500 includes a third portion 544 and a fourth portion 545. Specifically, the second portion 535 of the first radiation element 530 has a first open end 531, and the fourth portion 545 of the second radiation element 540 has a second open end 541. It should be noted that the second open end 541 of the second radiation element 540 and the first open end 531 of the first radiation element 530 substantially extend in opposite directions. Other features of the mobile device 500 of FIG. 5 are similar to those of the mobile device 100 of FIG. 1 and FIG. 2. Accordingly, the two embodiments can achieve similar levels of performance.

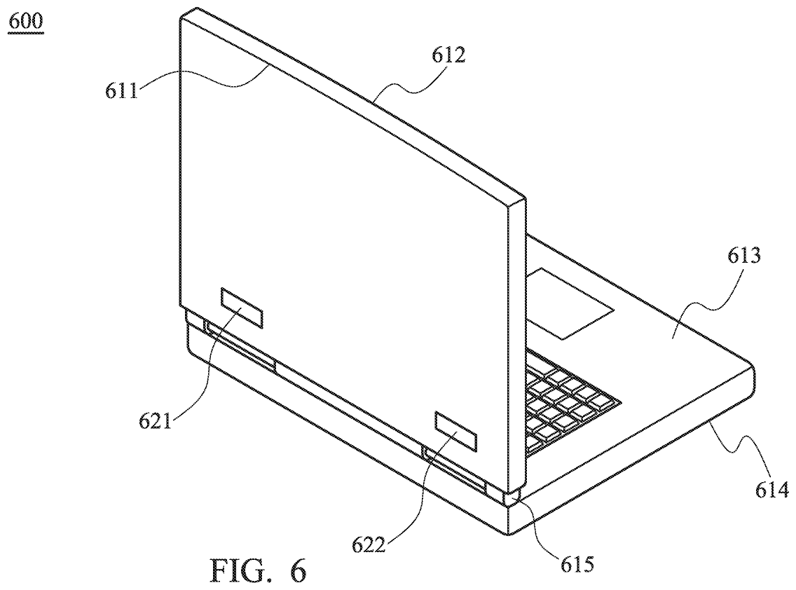

FIG. 6 is a diagram of a notebook computer 600 according to an embodiment of the invention. In the embodiment of FIG. 6, the aforementioned antenna structure is applied to the notebook computer 600. The notebook computer 600 includes an upper cover housing 611, a display frame 612, a keyboard frame 613, a base housing 614, and a hinge element 615. It should be understood that the upper cover housing 611, the display frame 612, the keyboard frame 613, and the base housing 614 are equivalent to the so-called “A-component”, “B-component”, “C-component”, and “D-component” in the field of notebook computers, respectively. The upper cover housing 611 may be made of a metal material, and it may be considered as the aforementioned metal mechanism element 110. In addition, the aforementioned closed slot 120 may be formed at a first position 621 or a second position 622 of the upper cover housing 611, and the aforementioned closed slot 120 may be adjacent to the hinge element 615, but it is not limited thereto. According to practical measurements, such a design not only enhances the robustness of the upper cover housing 611 (because the closed slot 120 does not extend to any edge of the upper cover housing 611, the upper cover housing 611 has no edge disconnection point) but also maintains the communication quality of the antenna structure.

The invention proposes a novel mobile device and a novel antenna structure, which may be integrated with a metal mechanism element. Since the metal mechanism element is considered as an extension portion of the antenna structure, it does not negatively affect the radiation performance of the antenna structure. Furthermore, the robustness of the metal mechanism element can be maintained by using the closed slot of the metal mechanism element to form the antenna structure. In comparison to the conventional design, the invention has the advantages of high robustness, small size, wide bandwidth, low manufacturing cost, and beautiful device appearance, and therefore it is suitable for application in a variety of mobile communication devices (especially for those with narrow borders).

Note that the above element sizes, element shapes, and frequency ranges are not limitations of the invention. An antenna designer can fine-tune these settings or values according to different requirements. It should be understood that the mobile device and the antenna structure of the invention are not limited to the configurations of FIGS. 1-6. The invention may merely include any one or more features of any one or more embodiments of FIGS. 1-6. In other words, not all of the features displayed in the figures should be implemented in the mobile device and the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device, comprising:
a metal mechanism element, wherein a closed slot is formed in the metal mechanism element, and the closed slot has a first edge and a second edge opposite to each other;
a first radiation element, having a feeding point;
a second radiation element, coupled to the first edge of the closed slot, and disposed adjacent to the first radiation element, wherein the second radiation element is at least partially disposed between the first radiation element and the second edge of the closed slot; and
a dielectric substrate, wherein the first radiation element and the second radiation element are disposed on the dielectric substrate;
wherein an antenna structure is formed by the first radiation element, the second radiation element, and the closed slot of the metal mechanism element.

2. The mobile device as claimed in claim 1, wherein the closed slot of the metal mechanism element substantially has a rectangular shape.

3. The mobile device as claimed in claim 1, wherein the first radiation element substantially has a relatively short L-shape.

4. The mobile device as claimed in claim 1, wherein the second radiation element substantially has a relatively long L-shape.

5. The mobile device as claimed in claim 1, wherein the first radiation element has a first vertical projection on the metal mechanism element, and the whole first

6. The mobile device as claimed in claim 1, wherein the second radiation element has a second vertical projection on the metal mechanism element, and the whole second vertical projection is inside the closed slot.

7. The mobile device as claimed in claim 1, wherein a coupling gap is formed between the first radiation element and the second radiation element.

8. The mobile device as claimed in claim 7, wherein a width of the coupling gap is shorter than or equal to 2 mm.

9. The mobile device as claimed in claim 1, wherein the first radiation element comprises a first portion and a second portion which are substantially perpendicular to each other.

10. The mobile device as claimed in claim 9, wherein the second radiation element comprises a third portion and a fourth portion which are substantially perpendicular to each other.

11. The mobile device as claimed in claim 10, wherein the fourth portion of the second radiation element is substantially parallel to the second portion of the first radiation element.

12. The mobile device as claimed in claim 10, wherein the second portion of the first radiation element has a first open end, the fourth portion of the second radiation element has a second open end, and the second open end and the first open end extend in directions that are substantially the same or opposite.

13. The mobile device as claimed in claim 1, wherein the antenna structure covers a first frequency band from 2400 MHz to 2500 MHz, and a second frequency band from 5150 MHz to 5850 MHz.

14. The mobile device as claimed in claim 13, wherein a length of the first radiation element is substantially equal to 0.25 wavelength of the second frequency band.

15. The mobile device as claimed in claim 13, wherein a length of the second radiation element is from 0.25 to 0.5 wavelength of the first frequency band.
